(19) United States
(12) Patent Application Publication
(10) Pub. No.: US 2023/0169943 A1
(43) Pub. Date: Jun. 1, 2023

(54) MUSICAL PERFORMANCE APPARATUS, MUSICAL PERFORMANCE PHRASE DETERMINING METHOD, AND STORAGE MEDIUM

(71) Applicant: CASIO COMPUTER CO., LTD., Tokyo (JP)

(72) Inventor: Yukina ISHIOKA, Tokyo (JP)

(73) Assignee: CASIO COMPUTER CO., LTD., Tokyo (JP)

(21) Appl. No.: 17/967,032

(22) Filed: Oct. 17, 2022

(30) Foreign Application Priority Data
Nov. 30, 2021 (JP) 2021-193722

(51) Int. Cl. G10H 1/36

(52) U.S. Cl. CPC G10H 1/366; G10H 2220/011

(57) ABSTRACT

A musical performance apparatus including at least one processor configured to: determine any phrase as a first phrase that is to be a performance target performed by a user from among a plurality of phrases included in a musical piece, and determine a set of phrases from the first phrase to a second phrase to be phrases that are to be the performance target performed by the user according to operation by the user in order to select the second phrase from the plurality of phrases.

### CROSS-REFERENCE TO RELATED APPLICATIONS

This application is based upon and claims the benefit of priority under 35 USC 119 of Japanese Patent Application No. 2021-193722, filed on Nov. 30, 2021, the entire disclosure of which, including the description, claims, drawings, and abstract, is incorporated herein by reference in its entirety.

### BACKGROUND

### Technical Field

The present disclosure relates to a musical performance apparatus, musical performance phrase determining method, and storage medium.

### Description of Related Art

Conventionally, there is a well-known automatic practicing apparatus for keyboard musical instruments in which model musical performance information is set in a unit of phrases, a comparison is made for each phrase with the musical performance information input on a keyboard for practicing and a score is provided. When the result of the score does not reach a score set as a standard, the same phrase can be performed repeatedly (for example, JP S56-92563).

### SUMMARY

The technique as described in JP S56-92563 effective for repeatedly performing and practicing each phrase. However, it is not possible to gradually increase the range that is practiced to complete one piece of music, as in a typical piano lesson. That is, when each phrase is practiced and then the entire musical piece is practiced, it is difficult to practice keeping in mind connections between the phrases and expressions of the musical piece.

The advantages of the present disclosure is that it is possible to practice keeping in mind connections between the phrases and expressions of the musical piece.

According to one aspect of the present disclosure, a musical performance apparatus including at least one processor configured to: determine any phrase as a first phrase that is to be a performance target performed by a user from among a plurality of phrases included in a musical piece, and determine a set of phrases from the first phrase to a second phrase to be phrases that are to be the performance target performed by the user according to operation by the user in order to select the second phrase from the plurality of phrases.

### BRIEF DESCRIPTION OF DRAWING

FIG. 1 is a block diagram showing a functional configuration of an electronic musical instrument according to the present embodiment.

FIG. 2 is a flowchart showing a flow of a musical performance practicing process performed by a controller shown in FIG. 1.

FIG. 3 is a diagram showing a data storage example of a phrase command management array.

FIG. 4 a flowchart showing a flow of a phrase lesson basic process performed by the controller shown in FIG. 1.

FIG. 5 is a flowchart showing a flow of a phrase connection mode process performed by the controller shown in FIG. 1.

FIG. 6 is a flowchart showing a flow of a recommended connection destination display process performed by the controller shown in FIG. 1.

FIG. 7 is a flowchart showing a flow of the recommended connection destination display process performed by the controller shown in FIG. 1.

### DETAILED DESCRIPTION

Embodiments to implement the present disclosure are described below with reference to the drawings. Various technically preferable limitations in order to implement the present disclosure are attached to the embodiments described below. Therefore, the technical range of the disclosure is not limited to the embodiments and the illustrated examples described below.

### Configuration of Electronic Musical Instrument 100

An embodiment of the musical performance apparatus according to the present disclosure is described providing an electronic musical instrument 100 which is an electronic keyboard instrument as the example.

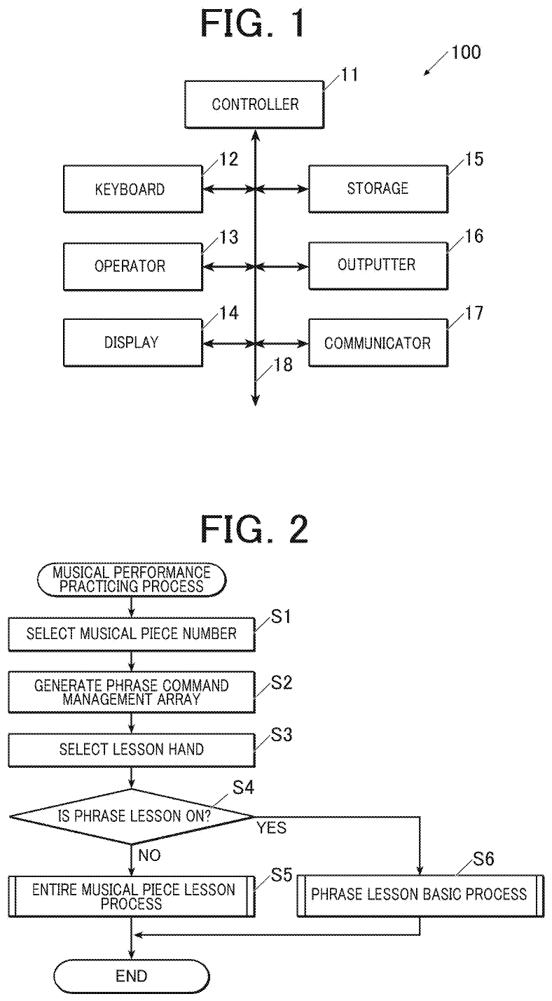

FIG. 1 is a block diagram showing a functional configuration of the electronic musical instrument 100. As shown in FIG. 1, the electronic musical instrument 100 includes a controller 11, a keyboard (musical performance operated tool) 12, an operator 13, a display 14, a storage 15, an outputter 16, and a communicator 17. Each unit is connected to each other by a bus 18.

The controller 11 includes at least one CPU (Central Processing Unit), a ROM (Read Only Memory), and a RAM (Random Access Memory). The CPU of the controller 11 reads the program and the data stored in the ROM, and performs various processes using the RAM as the work area. With this, the CPU of the controller 11 centrally controls each unit of the electronic musical instrument 100. For example, the controller 11 performs the later-described musical performance practicing process and supports the user practicing the musical performance.

The keyboard 12 includes a plurality of keys (operated tool), and a detector that detects the pressed key and the released key. The keyboard 12 outputs to the controller 11 information regarding the pitch and the timing of the pressed key and the released key.

The operator 13 includes various switches such as a musical piece selection switch, a play switch, a cursor switch and the like and operation buttons. The operator 13 outputs to the controller 11 operation information of the various switches and the operation buttons operated by the user.

The display 14 includes a LCD (Liquid Crystal Display) and performs display according to instructions of display signals input from the controller 11.

The storage 15 includes a nonvolatile semiconductor memory, hard disk, and the like and stores various data. The storage 15 stores musical piece data of a plurality of pieces of music. The musical piece data is stored corresponded with a musical piece number in order to identify the musical piece. The musical piece data includes information showing the timing of on and off of the note for a right hand part and a left hand part (timing of pressing the key and releasing the key), a pitch, and the like. Moreover, a plurality of phrase commands are embedded in the musical piece data. The phrase command is information showing an end of a phrase (a segment in a flow of music) and is embedded in a position showing the end of the phrase in the musical piece data. A final phrase command (phrase EOT) showing there are no more phrases is embedded at the finish of the musical piece data. The musical piece data includes information regarding a beat. The controller 11 determines the position of the end of the measure based on the beat information and the tick information.

The storage 15 may store the program to operate the electronic musical instrument 100 and the parameters necessary to execute the programs.

The outputter 16 includes a sound source, a D/A convertor, an amplifier, a speaker, and the like. According to an instruction from the controller 11, the outputter 16 uses the sound source to read waveform data stored in advance in a waveform ROM provided in the sound source or generates the waveform data, and outputs the sound based on the waveform data from the speaker.

The communicator 17 includes a wireless unit or a wired unit to communicate with external devices. The communicator 17 performs data communication with external devices based on control by the controller 11.

### Operation of Electronic Musical instrument 100

Next, the operation of the electronic musical instrument 100 is described.

FIG. 2 is a flowchart showing a flow of a musical performance practicing process to support users in practicing the musical performance. The musical performance practicing process as shown in FIG. 2 is performed in coordination with the program stored in the CPU and the ROM of the controller 11 according to the operation of the operator 13 performed by the user. The musical performance practicing process is described.

When the musical piece number is selected by the musical piece selecting switch of the operator 13 (step S1), the controller 11 reads the musical piece data of the selected musical piece number from the storage 15, and generates a phrase command management array 111 (step S2).

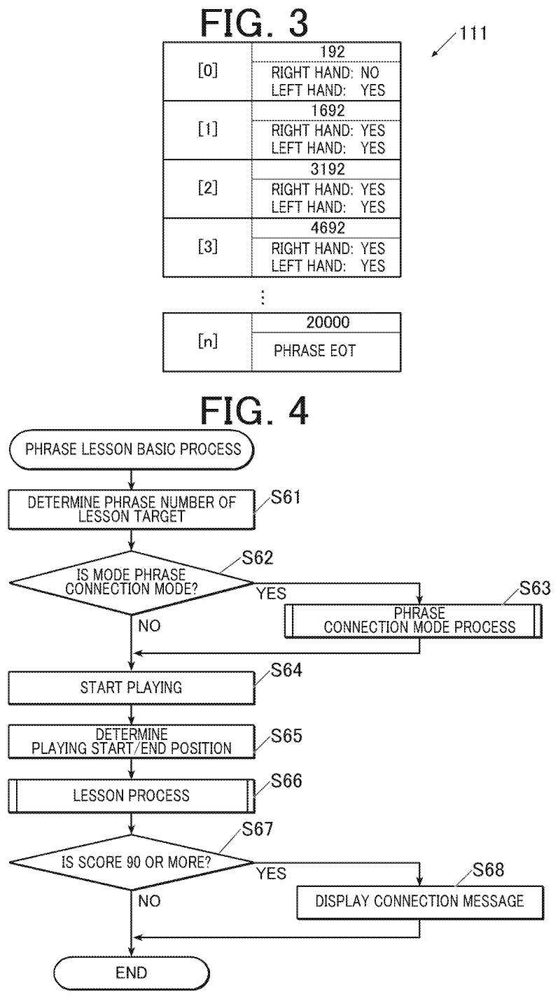

FIG. 3 is a diagram showing a data storage example of the phrase command management array 111. As shown in FIG. 3, the phrase command management array 111 stores phrase command position information (for example, 192, 1692, etc. in FIG. 3) and lesson presence information (for example, right hand: no, left hand: yes in FIG. 3) for each of the phrase [0] to phrase [n] (n is the number of phrases of the selected musical piece).

For example, the phrase command position information information showing the position of The phrase command in each phrase included in the musical piece data by the number of ticks from the beginning of the musical piece. The range of 1 phrase is between phrase commands in the musical piece data, and the range of an m-th (m may be any number between 0 to n−1) phrase can be shown as the range between the position shown by the m-th phrase command position information and the position shown by the m+1-th phrase command position information. For example, the 0-th phrase is from the position shown by the phrase command position information of the array [0] to the position shown by the phrase command position of the array [1].

The lesson presence information is information showing whether there is right hand lesson information and whether there is left hand lesson information in the range of the phrase or information showing that it is the end of the phrase (phrase EOT). The presence of the lesson information for the left hand and the right hand shows whether there is a part that the user plays with each hand in the range of the phrase. For example, if there is a part performed by the right hand in the range of the phrase, the lesson information of the right hand shows yes, and if there are no parts to be performed by the right hand, the lesson information of the right hand shows no. For example, there is no lesson information for the right hand in a phrase in which there is only an accompaniment played by the left hand in the introductory portion. In a phrase in which the musical performance is only performed automatically in the bridge portion and the user does not need to play, there is no lesson information for both the left and the right hand.

Next, the controller 11 receives selection of the hand that is the target of the lesson on the operator 13 (lesson hand; right hand, left hand, or both hands) (step S3).

Next, the controller 11 determines whether a phrase lesson is turned on (step S4). The phrase lesson is the lesson performed in a unit of phrases. The initial setting of the phrase lesson is off, but the on and off of the phrase lesson can be switched by predetermined operation on the operator 13. The state of on or off of the phrase lesson is stored in the RAM.

When it is determined that the phrase lesson is turned off (step S4; NO), the controller 11 performs an entire musical piece lesson process to play through the entire musical piece (step S5).

When it is determined that the phrase lesson is turned on (step S4; YES), the controller 11 advances the process to a phrase lesson basic process (step S6).

The phrase lesson basic process is described in detail below.

FIG. 4 is a diagram showing a flow of the phrase lesson basic process. The phrase lesson basic process is performed by the CPU of the controller 11 in coordination with the program stored in the ROM.

First, the controller 11 determines a phrase number (lesson target phrase number) of the phrase (any first phrase included in a plurality of phrases) that is to be a lesson target (target of musical performance by the user) (step S61).

Here, the default phrase number of the lesson target is 0, but other phrase numbers can be selected by the user operating the operator 13 (user operation). A phrase range including a plurality of consecutive phrase numbers may be selected. When one or a plurality of phrase numbers are selected by user operation, the controller 11 determines the selected phrase number as the lesson target phrase number, and stores the determined phrase number corresponded with the name of the musical piece in the RAM. When the phrase lesson is repeatedly performed for the same musical piece, the controller 11 may determine the phrase number stored in the RAM to be the lesson target phrase number. That is, the phrase number of the phrase that was the lesson target in the previous phrase lesson may be determined to be the lesson target phrase number.

Next, the controller 11 provides an option to the user regarding whether to select a phrase connection mode, and determines whether the phrase connection. mode is selected (step S62).

Here, the phrase connection mode is a mode in which another phrase (second phrase) different from the lesson target phrase (first phrase) selected at present is connected to the lesson target phrase. By performing the lesson connecting one or a plurality of phrases before or after the phrase selected as the lesson target, it is possible to practice the connection and flow of the musical piece between the phrases.

When it is determined that the phrase connection mode is not selected (step S62; NO), the controller 11 progresses the process to step S64.

When it is determined that the phrase connection mode is selected (step S62; YES), the controller 11 performs the phrase connection mode process (step S63), and the process progresses to step S64.

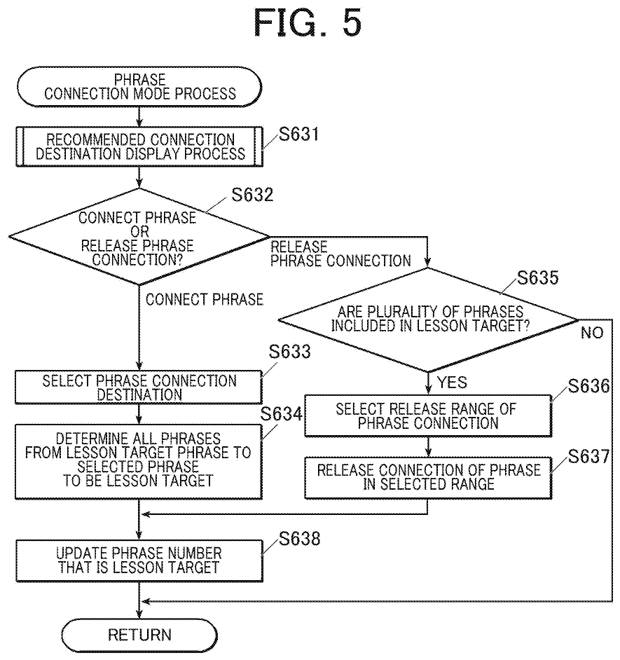

FIG. 5 is a diagram showing a flow of the phrase connection mode process. The phrase connection mode process is performed by the CPU of the controller 11 coordination with the program stored in the ROM.

In the phrase connection mode process, the controller 11 first performs a recommended connection destination display process (step S631).

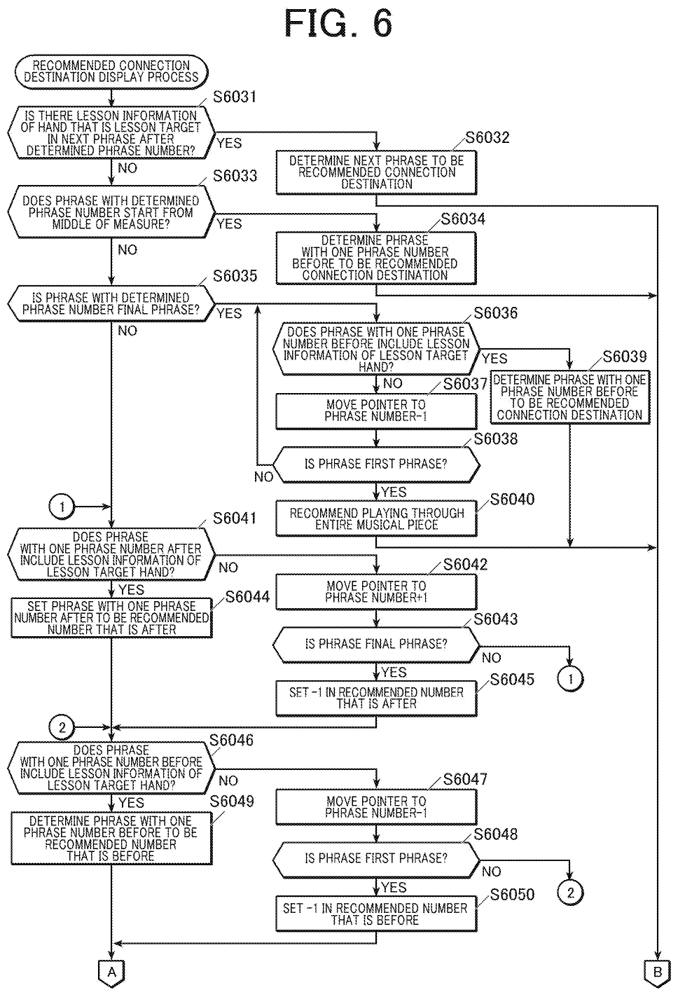

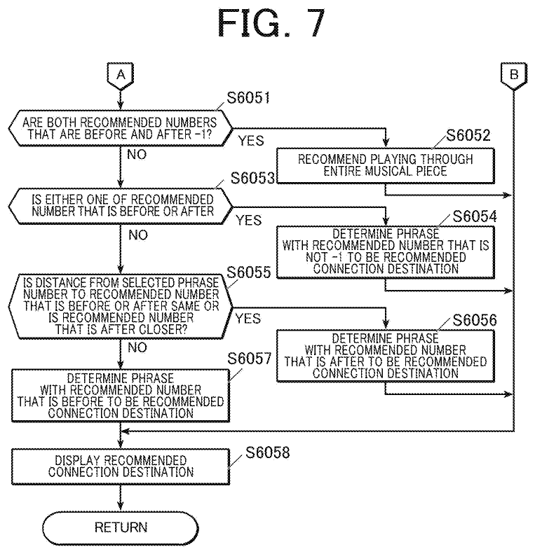

FIG. 6 to FIG. 7 compose a flowchart showing a flow of the recommended connection destination display process. The recommended connection destination display process is performed by the CPU of the controller 11 in coordination with the program stored in the ROM.

In the recommended connection destination display process, first, the controller 11 refers to the phrase command management array 111 stored in the RAM, and determines whether there is lesson information of the hand that is the lesson target in the phrase with the next phrase number following the phrase number determined in step S61 (when it is the phrase range, the last phrase number) (step S6031).

When it is determined that there is the lesson information of the hand that is the lesson target in the phrase with the next phrase number following the phrase number determined in step S61 (step S6031; YES), the controller 11 determines the phrase with the next phrase number following the phrase number determined in step S61 to be the recommended connection destination (step S6032), and the process progresses to step S6058.

When it is determined that there is no lesson information for the hand that is the lesson target in the phrase with the next phrase number following the phrase number determined in step S61 (step S6031; NO), the controller 11 progresses the process to step S6033.

In step S6033, the controller 11 determines whether the start position of the phrase (when it is the phrase range, first phrase number) with the phrase number determined in step S61 starts from the middle of the measure (step S6033).

In step S6033, the controller 11 refers to the phrase command management array 111 and the musical piece data and determines whether the phrase start position of the phrase number determined in step S61 is a position other than the beginning of the measure (position in the middle of the measure).

When it is determined that the start position of the phrase of the phrase number determined in step S61 is the position in the middle of the measure (step S6033; YES), the controller 11 determines the phrase with the phrase number one before the phrase number determined in step S61 to be the recommended connection destination (step S6034), and the process progresses to step S6058.

Here, when the start position of the phrase that is the lesson target is in the middle of the measure, usually the flow of the musical piece is connected from the previous phrase. Therefore, in this case, the user is able to effectively practice connection of the musical piece by playing the phrase connected with the phrase that is one before. Therefore, when the start position of the phrase that is the lesson target is in the middle of the measure, the phrase with the phrase number that is one before is determined to be the connection destination.

When the start position of the phrase with the phrase number determined in step S61 is determined not to be in the position in the middle of the measure (step S6033; NO), the controller 11 advances the process to step S6035.

In step S6035, the controller 11 refers to the phrase command management array 111, and determines whether the phrase with the phrase number determined in step S61 (when in the phrase range, final phrase number) is the final phrase (step S6035).

When it is determined that the phrase with the phrase number determined in step S61 is the final phrase (step S6035; YES), the controller 11 refers to the phrase command management array 111, and determines whether there is the lesson information for the hand that is the lesson target in the phrase with the phrase number that is one before (step S6036).

When it is determined that there is no lesson information for the hand that is the lesson target in the phrase with the phrase number that is one before (step S6036; NO), the controller 11 moves the pointer to the phrase number −1 (step S6037), and determines whether it is the first phrase (step S6038). When it is determined that it is not the first phrase (step S6038; NO), the controller 11 returns the process to step S6036. In step S6036, when it is determined that there is the lesson information for the hand that is the lesson target in the phrase with the phrase number that is one before (step S6036; YES), the controller 11 determines the phrase with the phrase number that is one before to be the recommended connection destination (step S6039), and the process advances to step S6058.

In step S6038, when it is determined that it is the first phrase (step S6038; YES), the controller 11 determines playing through the entire musical piece to be the recommended connection destination (step S6040), and the process progresses to step S6058.

In step S6035, when it is determined that the phrase with the phrase number determined in step S61 is not The final phrase (step S6035; NO), the controller 11 refers to the phrase command management array 111, and determines whether there is the lesson information for the hand that is the lesson target in the phrase with the phrase number that is one after the phrase number determined in step S61 (step S6041).

When it is determined that there is no lesson information for the hand that is the lesson target in the phrase with the phrase number that is one after, (step S6041; NO), the controller 11 moves the pointer to the phrase number +1 (step S6042), and determines whether it is the final phrase (step S6043). When it is determined that it is not the final phrase (step S6043; NO), the controller 11 returns the process to step S6041.

In step S6041, when it is determined that there is the lesson information for the hand that is the lesson target in the phrase with the phrase number that is one after (step S6041; YES), the controller 11 sets the phrase number that is one after to be the recommended number that is after (step S6044). Then the process progresses to step S6046.

In step S6043, when it is determined that it is the final phrase (step S6043; YES), the controller 11 sets −1 to be the recommended number that is after (step S6045), and the process progresses to step S6046.

In steps S6041 to S6045, when it is determined that there is no lesson information for the hand that is the lesson target in the phrase that is one after the phrase (end) with the phrase number that is determined to be the present lesson target, even if a connection is made, the state becomes a waiting state without performing. Therefore, the phrase including the lesson information for the hand that is the lesson target is searched from the phrase that is determined to be the present lesson target to the final phrase of the musical piece. If the phrase is found, the phrase number of this phrase is set to be the recommended number that is after. If the search reaches the final phrase without finding the phrase including the lesson information for the hand that is the lesson target, −1 is set as the recommended number that is after in order to show that there is no lesson information for the hand that is the lesson target in the phrases that follow.

In step S6046, the controller 11 refers to the phrase command management array 111, and it is determined whether there is the lesson information for the hand that is the lesson target in the phrase with the phrase number one before the phrase number that is determined in step S61 (step S6046).

When it is determined that there is no lesson information for the hand that is the lesson target in the phrase with the phrase number one before (step S6046; NO), the controller 11 moves the pointer to the phrase number −1 (step S6047), and determines whether it is the first phrase (step S6048). When it is determined that it is not the first phrase (step S6048; NO), the controller 11 returns the process to step S6046.

In step S6046, when it is determined that there is lesson information for the hand that is the lesson target in the phrase with the phrase number that is one before (step S6046; YES), the controller 11 sets the phrase number that is one before to be the recommended number that is before (step S6049), and the process progresses to step S6051.

In step S6048, when it is determined that it is the first phrase (step S6048; YES), the controller 11 sets −1 to be the recommended number that is before (step S6050), and the process progresses to step S6051.

In steps S6046 to S6050, when there is no lesson information for the hand that is the lesson target in the phrase one before the phrase (first phrase) with the phrase number determined to be the present lesson target, even if a connection is made, the state becomes a waiting state without performing. The phrase including the lesson information for the hand that is the lesson target is searched from the phrase that is determined to be the present lesson target to the first phrase of the musical piece. Then, if the phrase including the lesson information for the hand that is the lesson target is found, the phrase number of this phrase is set to be the recommended number that is before. If the search reaches the first phrase without finding the phrase including the lesson information for the hand that is the lesson target, −1 is set as the recommended number that is before in order to show that there is no lesson information for the hand that is the lesson target in the phrases that are before.

In step S6051, the controller 11 determines whether both recommended numbers before and after are −1.

When it is determined that both recommended numbers before and after are −1 (step S6051; YES), the controller 11 determines playing through the entire musical piece to be the recommended connection destination (step S6052), and the process progresses to step S6058.

When it is determined that either one of the recommended connection destination before or after is not −1 (step S6051; NO, step S6053; YES), the controller 11 determines the recommended connection destination that is not −1 to be the final recommended connection destination (step S6054), and the process progresses to step S6058.

When it is determined that both recommended connection destinations before and after are not −1 (step S6051; NO, step S6053; NO), the controller 11 calculates the distance from the phrase number determined to be the recommended number that is before to the beginning of the phrase number determined in step S61 and the distance from the phrase number determined to be the recommended number that is after to the end of the phrase number determined in step S61. Then, it is determined whether the calculated distance is the same or the distance that is after is closer (step S6055).

When it is determined that the calculated distance is the same or the distance that is after is closer (step S6055; YES), the controller 11 determines the phrase with the recommended number that is after to be the recommended connection destination (step S6056), and the process progresses to step S6058.

When it is determined that the calculated distance that is before is closer (step S6055; NO), the controller 11 determines the phrase with the recommended number that is before to be the recommended connection destination (step S6057), and the process progresses to step S6058.

In step S6058, the controller 11 displays the information of the phrase that is the recommended connection destination (for example, phrase number, etc.) (step S6058), and the process progresses to step S632 shown in FIG. 5.

In step S632 shown in FIG. 5, the controller 11 provides the option to the user to select whether to connect the phrases or to release the connection of the phrases. When the selection is made to connect the phrases on the operator 13 (step S632; phrase connection), the user operates the operator 13 and selects the phrase number that is the phrase connection destination (step S633). In step S633, the phrase number that is different from the phrase number determined in step S61 is selected as the phrase connection destination.

When the phrase number selected as the phrase connection destination, the controller 11 determines as the lesson target phrase the range including all of the phrases from the phrase with the phrase number determined in step S61 to the phrase with the phrase number that is the phrase connection destination (step S634). Then, the controller 11 updates the lesson target phrase number that is stored in the RAM with the phrase number in the determined phrase range (step S638), and the process progresses to step S64 shown in FIG. 4.

For example, if the phrase number determined in step S61 is 1, and the phrase number of the phrase connection destination is 4, the phrases in the phrase numbers 1 to 4 are determined to be the next lesson target phrases. When the phrase number determined in step S61 is 4 and the phrase number that is the phrase connection destination is 1, the phrases with the phrase numbers 4 to 1 (that is, 1 to 4) are determined to be the next lesson target phrases. When the phrase numbers determined in step S61 is 1 to 3, and the phrase number that is the phrase connection destination is 5, the phrases with the phrase numbers 1 to 5 are determined to be the next lesson target phrases.

In step S632, when the phrase connection release is selected (step S632; phrase connection release), the controller 11 determines whether the plurality of phrase numbers are included in the lesson target phrase number (step S635). When it is determined that the plurality of phrase numbers are included in the lesson target phrase number (step S635; YES), the controller 11 provides the option to the user to select the phrase number in the range to release the phrase connection, and the phrase number in the phrase connection release range is selected on the operator 13 (step S636). Then, the controller 11 releases the phrase number of the selected range from the phrase connection destination (step S637). Then, the controller 11 updates the phrase number that is the lesson target stored in the RAM in the phrase range after release (step S638), and the process progresses to step S64 shown in FIG. 4.

In step S635, when it is determined that the plurality of phrase numbers are not included in the phrase number that is the lesson target (step S635; NO), the controller 11 advances the process to step S64 shown in FIG. 4.

In step S64 shown in FIG. 4, when it is instructed to start playing by the user pressing the play switch (step S64), the controller 11 refers to the phrase number that is the lesson target stored in the RAM and the phrase command management array 111, and determines a play start position and an end position (step S65). Here, the play start position is the phrase command position of the first phrase number that is the lesson target and the play end position is the phrase command position −1 of the last phrase number +1.

Then, the controller 11 sequentially reads the musical piece data of the selected musical piece from the play start position to the end position and performs the lesson process (step S66).

For example, in the lesson process, first, the controller 11 instructs the outputter 16 to output (that is, playing a phrase that is the lesson target) the sound based on the musical piece data of the phrase that is the lesson target in the selected musical piece. With this, the outputter 16 outputs (plays) the sound. Next, the user plays the phrase and the played sound based on the operation on the keyboard 12 is output by the outputter 16. Then, the played data (data showing the pitch and the timing of the pressed and released keys) based on the operation on the keyboard 12 is compared with the musical piece data in the range of the phrase, and the performance is scored. For example, the scoring is performed based on whether the pitch is correct, whether the timing is correct and the like. According to the present embodiment, the scoring is performed in the lesson process, but the process is not limited to the above. For example, the position of the key to be played may be lit on the keyboard 12 according to the musical piece data being played, and the user may perform according to this guide. For example, when the hand that is the lesson target is the right hand, the part for the left hand in the range of the phrase that is the lesson target may be played by the apparatus, and the user may perform the part for the right hand.

When the lesson process ends, the controller 11 determines whether the score is larger than a predetermined score, for example, 90 or more points (step S67).

When it is determined that the score is 90 or more points (step S67; YES), the controller 11 displays a connection message on the display 14 (step S68), and ends the phrase lesson basic process.

The connection message is a message that suggests phrase connection, for example, “Would you like to expand the range of the lesson?”.

The controller 11 may perform the above-described recommended connection destination display process in step S68, and may display the information of the phrase that is the recommended connection destination recommended as the phrase to be connected to the phrase that is the lesson target selected at present.

When it is determined that the score is less than 90 points (step S67; NO), the controller 11 ends the phrase lesson basic process.

When the user desires to perform the lesson repeatedly using the same phrase of the same musical piece as the one used in the previous lesson, for example, if the user presses the play switch, the controller 11 performs the process from step S64 and after in the phrase lesson basic process, and the lesson may be performed repeatedly. When the user desires to perform the lesson using another phrase from the same musical piece, for example, if the phrase number is selected, the controller 11 determines the selected phrase number as the phrase number that is the lesson target, and performs the phrase lesson basic process. When the user desires to perform a lesson connecting another phrase to the same phrase of the same musical piece as the one used in the previous lesson, for example, if the phrase connection mode is selected by a predetermined operation on the operator 13, the controller 11 performs the process performed from step S63 and after in the phrase lesson basic process, and the user is able to perform the lesson using the phrase used in the previous lesson and the other phrases selected by the user as the lesson target. That is, the user is able to perform the lesson expanding the range of the phrases from the phrases used in the previous lesson.

As described above, according to the controller 11 of the electronic instrument 100, any first phrase is selected as the target to be performed by the user from the plurality of phrases included in the selected musical piece, and according to the user operation that selects from the plurality of phrases the second phrase different from the first phrase to be connected to the first phrase, the plurality of phrases from the first phrase to the second phrase are determined as the phrases that are the target of musical performance by the user.

Therefore, since the range of the phrase performed by the user can be expanded from the first phrase, the user is able to perform practice keeping in mind the connection between the phrases and the expression of the musical piece.

The controller 11 determines the recommended phrase recommended as the second phrase from the plurality of phrases included in the selected musical piece, and displays the information of the determined recommended phrase on the display 14.

Therefore, the user is able to easily understand which phrase should be connected, and it is possible to expand the range that the user plays and to support the practice of the user's performance.

When the first phrase starts from the middle of the measure, the controller 11 determines the phrase that is one before the first phrase as the recommended phrase. Therefore, it is possible to recommend to the user connection of the phrase with high effect in practicing the connection between phrases.

When the phrase that is one before the first phrase or the phrase that is one after includes the operation of the musical performance that is to be performed by the user, the controller 11 determines the phrase that is one before or one after the first phrase to be the recommended phrase. When the phrase that is one before the first phrase or the phrase that is one after does not include the operation of the musical performance that is to be performed by the user, the phrase that includes the operation of the musical performance to be performed by the user and that is closest to the first phrase is determined to be the recommended phrase. Therefore, the phrase that includes the operation of the musical performance to be performed by the user and that is closest to the first phrase can be recommended to the user to be the phrase to be connected.

The controller 11 scores the musical performance data based on the comparison between the musical performance data of the first phrase based on the operation of the musical performance on the keyboard 12 and the musical piece data of the portion of the first phrase. When the scored result reaches a threshold value, the display suggesting the recommended phrase recommended as the second phrase is displayed on the display 14. Therefore, it is possible to encourage the user to connect another phrase when the musical performance of the phrase reaches a certain standard. With this, it is possible to support effective practice.

The controller 11 instructs the outputter 16 to play the phrase determined to be the target to be performed by the user. Therefore, the user is able to listen to a performance that serves as a model of the determined phrase, and it is possible to support effective practice.

The description of the above embodiments are merely one preferable example of the musical performance apparatus, musical performance phrase determination method, and storage medium storing a program according to the present disclosure. The present disclosure is not limited to the above. For example, according to the above embodiments, the musical performance apparatus of the present disclosure is included in the electronic instrument 100, but the configuration is not limited to the above. For example, the functions of the musical performance apparatus according to the present disclosure can be provided in an electronic device (for example, PC (personal computer), tablet terminal, and smartphone) connected to the electronic instrument 100 through a wired or wireless communication interface.

According to the present embodiment, when the scored result is a predetermined threshold or more, the message recommending connection is displayed. Alternatively, when the scoring result is a predetermined threshold or more, a range in which a new phrase is connected automatically to the present lesson target phrase may be the range of the phrase that is the next lesson target. For example, the recommended connection destination may be determined by the flow similar to the recommended connection destination display process as shown in FIG. 6 to FIG. 7, and the range automatically connecting the determined recommended connection destination may be set as the range of the phrase that is the next lesson target.

According to the present embodiment, the electronic musical instrument 100 described here is an electronic keyboard instrument. However, the electronic musical instrument 100 is not limited to the above, and may be, other electronic instruments such as an electronic string instrument, an electronic wind instrument, or the like.

According to the present embodiment, a semiconductor memory such as a ROM or a hard disk is used as the computer-readable medium for the program of the present disclosure, but the media is not limited to the above. An SSD or a portable storage medium such as a CD-ROM may be used as other computer-readable storage media. As the medium that provides the data of the program regarding the present disclosure through a communication line, a carrier wave may be applied.

The detailed configuration and the detailed operation of the electronic musical instrument can be suitably changed without leaving the scope of the present disclosure.

Embodiments of the present disclosure are described above, but the technical scope of the present disclosure is not limited to the above-described embodiments. The scope of the present disclosure is determined as described in the attached claims. Modifications not related to the essence of the present disclosure may be added to the details as described in the attached claims, but such equivalents are also included in the technical scope of the present disclosure.

What is claimed is:

1. A musical performance apparatus comprising at least one processor configured to:
determine any phrase as a first phrase that is to be a performance target performed by a user from among a plurality of phrases included in a musical piece, and
determine a set of phrases from the first phrase to a second phrase to be phrases that are to be the performance target performed by the user according to operation by the user in order to select the second phrase from the plurality of phrases.

2. The musical performance apparatus according to claim 1, wherein the at least one processor is configured to,
determine from the plurality of phrases a recommended phrase that is recommended as the second phrase, and
control a display to display information of the determined recommended phrase.

3. The musical performance apparatus according to claim 2, wherein the at least one processor is configured to determine a phrase that is one before the first phrase to be the recommended phrase when the first phrase starts from a middle of a measure.

4. The musical performance apparatus according to claim 2, wherein the at least one processor is configured to,
determine the phrase that is one before or one after the first phrase to be the recommended phrase when there is an operation of a musical performance that the user should perform in the phrase that is one before or one after the first phrase, and
determine the phrase that includes the operation of the musical performance that the user should perform and that is closest to the first phrase as the recommended phrase when the phrase that is one before or one after the first phrase does not include the operation of the musical performance that the user should perform.

5. The musical performance apparatus according to claim 1, wherein the at least one processor is configured to,
score musical performance data based on a comparison between musical performance data of the first phrase based on operation of a musical performance and musical piece data of a portion of the first phrase, and
control a display to display a suggestion of a recommended phrase recommended as the second phrase when a scored result reaches a threshold.

6. A musical performance phrase determining method executed by a computer to perform:
determining any phrase as a first phrase that is to be a performance target performed by a user from among a plurality of phrases included in a musical piece, and
determining a set of phrases from the first phrase to a second phrase to be phrases that are to be the performance target performed by the user according to operation by the user on an input apparatus in order to select the second phrase from the plurality of phrases.

7. The musical performance phrase determining method according to claim 6, wherein the computer performs,
determining from the plurality of phrases a recommended phrase that is recommended as the second phrase, and
controlling a display to display information of the determined recommended phrase.

8. The musical performance phrase determining method according to claim 7, wherein the computer performs determining a phrase that is one before the first phrase to be the recommended phrase when the first phrase starts from a middle of a measure.

9. The musical performance phrase determining method according to claim 7, wherein the computer performs,
determining the phrase that is one before or one after the first phrase to be the recommended phrase when there is an operation of a musical performance that the user should perform in the phrase that is one before or one after the first phrase, and
determining the phrase that includes the operation of the musical performance that the user should perform and that is closest to the first phrase as the recommended phrase when the phrase that is one before or one after the first phrase does not include the operation of the musical performance that the user should perform.

10. The musical performance phrase determining method according to claim 6, wherein the computer performs,
scoring musical performance data based on a comparison between musical performance data of the first phrase based on operation of a musical performance and musical piece data of a portion of the first phrase, and
controlling a display to display a suggestion of a recommended phrase recommended as the second phrase when a scored result reaches a threshold.

11. A non-transitory computer-readable storage medium having a program stored thereon for controlling a computer to perform the process of:
determining any phrase as a first phrase that is to be a performance target performed by a user from among a plurality of phrases included in a musical piece, and
determining a set of phrases from the first phrase to a second phrase to be phrases that are to be the performance target performed by the user according to operation by the user on an input apparatus in order to select the second phrase from the plurality of phrases.

12. The storage medium according to claim 11, wherein the computer performs the process of,
determining from the plurality of phrases a recommended phrase that is recommended as the second phrase, and
controlling a display to display information of the determined recommended display.

13. The storage medium according to claim 12, wherein the computer performs determining a phrase that is one before the first phrase to be the recommended phrase when the first phrase starts from a middle of a measure.

14. The storage medium according to claim 12, wherein the computer performs the process of,
determining the phrase that is one before or one after the first phrase to be the recommended phrase when there is an operation of a musical performance that the user should perform in the phrase that is one before or one after the first phrase, and
determining the phrase that includes the operation of the musical performance that the user should perform and that is closest to the first phrase as the recommended phrase when the phrase that is one after or one before the first phrase does not include the operation of the musical performance that the user should perform.

15. The storage medium according to claim wherein the computer performs the process of,
scoring musical performance data based on a comparison between musical performance data of the first phrase based on operation of a musical performance and musical piece data of a portion of the first phrase, and
controlling a display to display a suggestion of a recommended phrase recommended as the second phrase when a scored result reaches a threshold.
